(19) United States
(12) Patent Application Publication
(10) Pub. No.: US 2026/0177173 A1
(43) Pub. Date: Jun. 25, 2026

(54) BALL JOINT FOR THE PIPING OF AN ENGINE, AND ASSOCIATED PIPING AND AIRCRAFT

(71) Applicant: Safran Aerosystems, Plaisir (FR)

(72) Inventors: Jean-François Roche, Moissy-Cramayel (FR); Alexandre Aubertin, Moissy-Cramayel (FR)

(21) Appl. No.: 19/123,172

(22) PCT Filed: Oct. 24, 2023
(86) PCT No.: PCT/FR2023/000162

§ 371 Date: Apr. 22, 2025

(30) Foreign Application Priority Data
Oct. 24, 2022 (FR) 2210991

(51) Int. Cl. F16L 27/06; B64D 33/00

(52) U.S. Cl. CPC F16L 27/06; B64D 33/00

(57) ABSTRACT

This ball joint for the piping of an engine is intended to connect a first and a second fluid flow pipe to one another and is provided with an annular casing comprising an internal element intended to be mounted on the first flow pipe and an external element intended to be mounted on the second flow pipe, an annular bearing arranged transversely between the internal element and the external element so as to be in contact with the internal element and the external element, the ball joint comprising a metal bellows provided with a first end attached to the internal element and a second end opposite the first end and attached to the external element, the bellows comprising a stack of at least three metal layers.

### TECHNICAL FIELD

The present invention relates to a ball joint for the piping of an engine, in particular of an aircraft engine.

### PRIOR ART

Ball joints, or hinged joints, are intended to sealingly connect two fluid flow pipes to one another by allowing relative movement between the two flow pipes, for example a bending movement.

Such joints are necessary for the piping of engines in order to reduce overall size in the engine zone, the ball joints having to withstand stresses of temperatures, vibrations and high pressures, for example temperatures between 40° and 700° C., a vibration frequency up to 2000 Hz, an acceleration up to thirty times the acceleration of gravity to the surface of the earth, or 30 g, and up to 100 g under resonant conditions and pressures between 5 and 30 bar for an aircraft engine.

A ball joint comprises for example a female end piece having a substantially spherical end, a male end piece received in the female end piece and having a shoulder in the vicinity of its end, a ring threaded on the male end piece, the outer face of which is substantially spherical, and a bellows interposed between the female end piece and the male end piece to load the shoulder bearing against the ring so that the outer face of the ring is slidably bearing against the inner face of the substantially spherical end of the female end piece.

Existing ball joints do not effectively withstand stresses in the engine zone, in particular strong temperature fluctuations and vibrations of the engine. In particular, such joints are flexible, but do not allow sufficiently high damping against thermal and vibratory regimes of the engine.

The bellows is a thrust elastic element that allows the ball joint to be returned to a position in which the two flow pipes are aligned. The bellows is generally made of a flexible material that does not have intrinsic damping properties.

The ring only serves as a guide and does not allow the vibration resistance of the ball joint to be improved. The ring, located close to the flow pipes, is sensitive to the temperature of the fluid circulating in the flow pipes. This situation can lead to premature damage to the ring.

### DISCLOSURE OF THE INVENTION

The objective of the present invention is to overcome all or part of the aforementioned drawbacks.

One object of the present invention is a ball joint for the piping of an engine, the joint being intended to connect a first and a second fluid flow pipe to one another and being provided with an annular casing comprising an internal element intended to be mounted on the first flow pipe and an external element intended to be mounted on the second flow pipe, an annular bearing arranged transversely between the internal element and the external element so as to be in contact with the internal element and the external element, the ball joint comprising a metal bellows provided with a first end attached to the internal element and a second end opposite the first end and attached to the external element, the bellows comprising a stack of at least three metal layers.

Thus, the present invention allows a sealed connection between the two pipes, the at least three metal layers of the bellows having a significantly damping effect during engine vibrations. Friction between the at least three metal layers of the bellows generates damping, the increase in the number of metal layers of the bellows especially makes it possible to increase this damping.

Advantageously, the bellows comprises a stack of five metal layers.

Advantageously, the internal element extends longitudinally facing the bellows.

Optionally, the bellows comprises at least three convolutions, the internal element extending longitudinally facing at least two convolutions.

In one embodiment, the outer surface of the internal element intended to be in contact with the annular bearing is convex, the annular bearing comprising a concave inner surface slidably bearing against said outer surface.

Advantageously, said outer surface comprises PTFE and/or graphite and/or a ceramic material.

Optionally, the external element comprises a shoulder, the annular bearing slidably bearing against said shoulder.

In one embodiment, the annular bearing comprises a friable material.

Optionally, the annular bearing is located radially outwardly of the bellows when the first and second flow pipes are longitudinally aligned.

Advantageously, the friable material comprises graphite.

Another object of the invention is a piping comprising a first and a second fluid flow pipe, the piping comprising a ball joint as defined previously, the internal element being mounted on the first flow pipe and the external element being mounted on the second flow pipe so as to join the first and second flow pipes.

Another object of the present invention is an aircraft comprising a ball joint as defined previously and/or a piping as defined previously.

### BRIEF DESCRIPTION OF THE DRAWINGS

Other purposes, characteristics and advantages of the invention will become apparent upon reading the following description, provided solely as a non-limiting example and with reference to the appended drawings wherein:

FIG. 1 schematically illustrates an aircraft comprising a piping comprising a ball joint according to the invention; and

FIG. 2 schematically illustrates a ball joint according to the invention.

### DETAILED DESCRIPTION

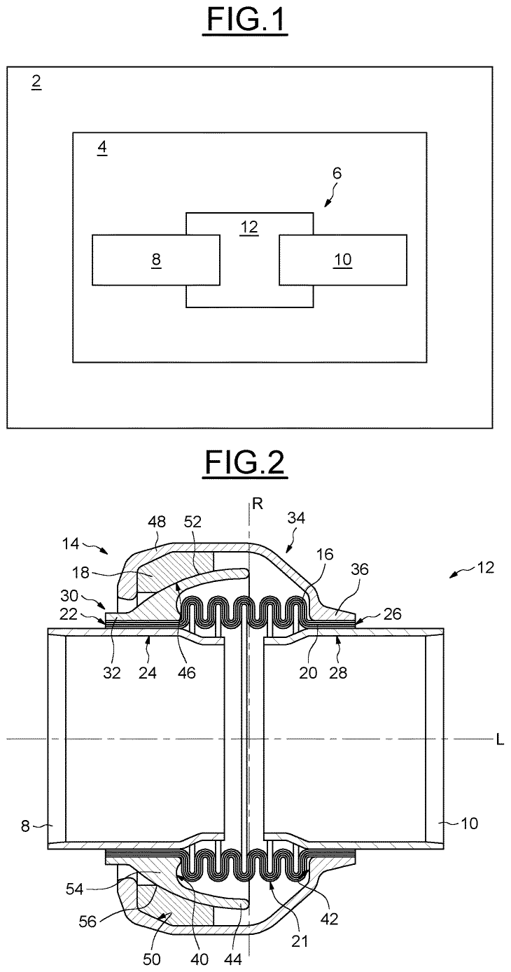

FIG. 1 schematically represents an aircraft 2 comprising an engine 4. The engine 4 comprises a piping 6 comprising a first flow pipe 8, a second flow pipe 10 and a ball joint 12. The first and second flow pipes 8, 10 are sealingly connected to one another by the ball joint 12. The ball joint 12 allows a relative movement between the first and second flow pipes 8, 10, for example a bending movement, especially making it possible to withstand conditions and vibrations in the engine zone 4, as well as allowing a smaller overall size in the engine zone 4 and therefore a reduced mass of the aircraft 2. The ball joint 12 also makes it possible to reduce stresses induced by mounting clearances between the first and second flow pipes 8, 10 or by thermal expansions of components of the engine 4 occurring during operation of the engine 4.

FIG. 2 schematically represents a detailed view of the ball joint 12 connecting the first and second flow pipes 8, 10, the first and second flow pipes 8, 10 extending longitudinally along the longitudinal axis L. The ball joint 12 comprises an annular casing 14, a metal bellows 16 and an annular bearing 18.

The metal bellows 16 is generally annular. The material constituting the bellows comprises a stack of at least three, preferably five, metal layers 20, the bellows 16 being represented herein as comprising a stack of five metal layers 20.

The bellows 16 comprising at least three metal layers 20 achieves a damping function especially by friction between adjacent metal layers 20. The number of metal layers 20 also makes it possible to increase the life time of the bellows 16, for example a bellows 16 comprising five metal layers 20 will have a life time ten times greater than a bellows 16 comprising four metal layers 20, a bellows 16 comprising five metal layers 20 will be less likely to resonate than a bellows comprising four metal layers 20.

Preferably, the metal layers 20 of the bellows 16 are movable with respect to one another. This characteristic makes it possible to generate a strong damping effect from friction between the metal layers 20.

A metal layer 20 of the bellows 16 comprises for example a thin metal plate cut out, rolled and welded longitudinally to form a ferrule. The different metal layers 20 of the bellows 16 are for example made in the form of concentric ferrules so as to obtain a tube comprised of several metal layers 20 closely spaced apart, i.e. spaced apart by no or negligible distance. A hydroforming method then makes it possible to create at least one convolution 21 in said tube to form the bellows 16.

A first end 22 of the bellows 16 is mounted on the first flow pipe 8. For example, the first end 22 is welded, stamped or machined to be sealingly connected to an end 24 of the first flow pipe 8.

A second end 26 of the bellows 16, opposite the first end 22, is mounted on the second flow pipe 10. For example, the second end 26 is welded, stamped or machined to be sealingly integral with an end 28 of the second flow pipe 10.

The annular casing 14 comprises an internal element 30 comprising a mounting portion 32 welded, stamped or machined to be sealingly integral with the first end 22 of the bellows 16.

The annular casing 14 also comprises an external element 34 comprising a mounting portion 36 welded, stamped or machined to be sealingly integral with the second end 26 of the bellows 16.

Preferably, the bellows 16 comprises several convolutions 21, the bellows 16 represented comprising for example five convolutions 21. The internal element 30 comprises a shoulder 40 bearing against the convolution 21 of the bellows 16 closest to the first end 22 of the bellows 16. The external element 34 comprises a shoulder 42 bearing against the convolution 21 of the bellows 16 closest to the second end 26 of the bellows 16. This configuration allows the bellows 16 to exert a pushing force on the inner and external elements 30, 34 so as to transfer compression forces tending to move the first and second flow pipes 8, 10 closer or away from each other.

The internal element 30 comprises an elongate portion 44 as an extension of the mounting portion 32 of the internal element 30 and extending longitudinally facing the bellows 16. The annular bearing 18 is threaded around the internal element 30. An inner surface 46 of the annular bearing 18 is in contact with the elongate portion 44 of the internal element 30.

The external element 34 comprises a curved portion 48 as an extension of the mounting portion 36 of the external element 34 so as to partially surround longitudinally the elongate portion 44. The annular bearing 18 comprises an outer surface 50, opposite the inner surface 46, in contact with the curved portion 48. In addition, the curved portion 48 forms a shoulder bearing on the complementary outer surface 50 of the annular bearing 18.

Advantageously, the outer surface of the internal element 30 intended to be in contact with the annular bearing 18 is convex, the inner surface 46 of the annular bearing 18 being concave. Thus, the annular bearing 18 is in sliding contact with the internal element 30, relative movements between the first and second flow pipes 8, 10 being facilitated. Advantageously, the outer surface of the internal element 30 intended to be in contact with the annular bearing 18 and the inner surface 46 of the annular bearing 18 are complementary and especially made as sphere portions so as to allow bending movement of the internal element 30 inside the external element 34, the bending movement corresponding for example to rotation of the internal element 30 about the radial axis R.

Preferably, the outer surface of the elongate portion 44 intended to be in contact with the annular bearing 18 forms a shoulder ensuring longitudinal and radial retention of the annular bearing 18 with respect to the external element 34.

The elongate portion 44 comprises for example PTFE and/or graphite and/or a ceramic material, for example the outer surface of the elongate portion 44 intended to be in contact with the annular bearing 18 is covered with PTFE or graphite or the ceramic material so as to facilitate relative movements between the first and second fluid flow pipes 8, 10. Advantageously, the material on the outer surface of the elongate portion 44 also participates in a damping function for the relative movement between the first and second flow pipes 8, 10.

Advantageously, the elongate portion 44 of the internal element 30 extends longitudinally facing several convolutions 21. Thus, it is possible to use an annular bearing 18 having a large inner surface 46 so as to increase the contact surface area between the annular bearing 18 and the internal element 30.

Preferably, the annular bearing 18 comprises a friable material, for example the annular bearing 18 is comprised of or covered with the friable material. The friable material comprises for example graphite.

The friable material releases particles of the friable material upon friction of the annular bearing 18 with the elongate portion 44 so as to form a solid lubricant layer 52. The friable material contributes to the damping character of the ball joint 12.

In one embodiment, the annular bearing 18 is formed of graphite and is obtained by sintering. Alternatively, the annular bearing 18 is formed by an equivalent powder metallurgy method.

Advantageously, the internal element 30 comprises a wedging portion 54 interposed between the mounting portion 32 of the internal element 30 and the elongate portion 44, so as to move the annular bearing 18 away from the fluid circulating in the first and second flow pipes 8, 10.

Moving the annular bearing 18 away from the first and second fluid flow pipes 8, 10 makes it possible to decrease the effect of the fluid temperature on the annular bearing 18 and especially to increase the resistance of the annular bearing 18 to oxidation, heat being an oxidation reaction catalyst. Moving away the annular bearing 18 makes it possible to increase the life time of the annular bearing 18.

Preferably, the wedging portion 54 extends radially outwardly from the mounting portion 32 of the internal element 30 such that an end 56 of the wedging portion 54 is located radially outwardly of the bellows 16 when the first and second flow pipes 8, 10 are longitudinally aligned, the annular bearing 18 in contact with the outer surface of the internal element 30 being thus located radially outwardly of the bellows 16. Stated differently, the minimum internal diameter of the annular bearing 18 is greater than the radial dimension of the bellows 16 measured when the first and second flow pipes 8, 10 do not undergo bending.

1. A ball joint for piping of an engine, the ball joint being intended to connect a first and a second fluid flow pipe to one another and being provided with an annular casing comprising an internal element intended to be mounted on the first flow pipe and an external element intended to be mounted on the second flow pipe, an annular bearing disposed transversely between the internal element and the external element so as to be in contact with the internal element and the external element, and a metal bellows provided with a first end attached to the internal element and a second end opposite the first end and attached to the external element, the bellows comprising a stack of five metal layers.

2. The ball joint according to claim 1, wherein the internal element extends longitudinally facing the bellows.

3. The ball joint according to claim 2, wherein the bellows comprises at least three convolutions, the internal element extending longitudinally facing at least two convolutions.

4. The ball joint according to claim 1, wherein the outer surface of the internal element intended to be in contact with the annular bearing is convex, the annular bearing comprising a concave inner surface slidably bearing against said outer surface.

5. The ball joint according to claim 4, wherein said outer surface comprises PTFE and/or graphite and/or a ceramic material.

6. The ball joint according to claim 1, wherein the external element comprises a shoulder, the annular bearing bearing against said shoulder.

7. The ball joint according to claim 1, wherein the annular bearing comprises a friable material, the friable material comprising graphite.

8. The ball joint according to claim 1, wherein the annular bearing is located radially outwardly of the bellows when the first and second flow pipes are longitudinally aligned.

9. A piping comprising a first and a second fluid flow pipe and a ball joint according to claim 1, the internal element being mounted on the first flow pipe and the external element being mounted on the second flow pipe so as to join the first and second flow pipes.

10. An aircraft comprising a ball joint according to claim 1 and/or a piping comprising a first and a second fluid flow pipe and the ball joint, the internal element being mounted on the first flow pipe and the external element being mounted on the second flow pipe so as to join the first and second flow pipes.
